(19) United States
(12) Patent Application Publication
(10) Pub. No.: US 2016/0285079 A1
(43) Pub. Date: Sep. 29, 2016

(54) Wet Method for the Production of Thin Films

(71) Applicants: PRAYON S.A., Engis (BE); UNIVERSITE DE LIEGE, B-An-gleur (BE)

(72) Inventors: Dimitri Liquet, Angleur (BE); Cedric Calberg, Esneux (BE); David Eskenazi, Liege (BE); Carlos Paez, Liege (BE); Jean-Paul Pirard, Chenee (BE); Benoit Heinrichs, Liege (BE); Christelle Alie, Liege (BE)

(21) Appl. No.: 15/033,622

(22) PCT Filed: Oct. 31, 2014
(86) PCT No.: PCT/EP2014/073450

§ 371 Date: Apr. 29, 2016

(30) Foreign Application Priority Data
Oct. 31, 2013 (BE) 2013/0742

(51) Int. Cl. H01M 4/1391; H01M 4/485; H01M 4/04; H01M 4/525; H01M 4/66; H01M 4/131; H01M 4/505

(52) U.S. Cl. CPC H01M 4/1391; H01M 4/131; H01M 4/485; H01M 4/505; H01M 4/525; H01M 4/662; H01M 4/0404; H01M 4/0419; H01M 4/0471

(57) ABSTRACT

A method produces thin films. The method includes preparing a solution containing transition metal oxide precursors, a chelating agent, and a polar organic solvent. The solution is agitated in order to form a sol. The sol is used in the form of the transition metal oxide film. The chelating agent is selected from among di- or tri-aliphatic carboxylic acids, or salts or mixtures thereof. The polar organic solvent has a boiling temperature at atmospheric pressure of less than 150° C.

### FIELD OF THE INVENTION

The invention relates to the manufacture of transition metal oxide films by wet processing, for example by sol-gel processing. In particular, the invention relates to the manufacture of, preferably thin, lithiated transition metal oxide films.

The invention also relates to the use of said film prepared according to the present invention as an electrode material in a battery, preferably a microbattery.

### DESCRIPTION OF RELATED ART

The use of microbatteries, such as Li-ion batteries, comprising thin metal oxide films has seen considerable growth in many fields of application. These thin films generally consist of lithiated transition metal oxides, oxides of cobalt, manganese or nickel for example. These oxides are the materials of choice for preparing electrode materials because of their high specific insertion capacity and their excellent cyclability.

Thin metal oxide films are mainly prepared by physical vapour deposition (PVD). This method consists in vaporising the material at low pressure and in condensing it on a substrate. Two other techniques are regularly employed to form thin films of transition metals: pulsed laser deposition (PLD) and radio-frequency cathode sputtering. PLD deposition is achieved using laser pulses fired at a target in order to evaporate the material. Radio-frequency cathode sputtering consists in creating an argon plasma in a deposition chamber in which the Ar ions mechanically bombard a target of the material in order to deposit it on a substrate. A step of annealing the material formed at a very high temperature is required in order to promote the definitive formation of the material. This very high-temperature annealing step is incompatible with integration of microaccumulators into a flexible electronic circuit. The slowness of these processes limits the capacity for industrial production. In addition, the capacity per unit weight of this type of thin film drops rapidly after a few charge/discharge cycles. Chemical vapour deposition (CVD—high-temperature vaporisation of transition metal precursors onto a substrate) is an alternative to the above techniques but these processes require higher temperatures. Furthermore, the expense associated with the investment required to deploy these technologies is very high.

In order to overcome the drawbacks of vacuum deposition techniques, preparation methods employing wet processing have been explored. The manufacture of thin LiCoO₂ films by sol-gel processing is for example known from Kim et al., Journal of Power Sources, 99, 2001, 34-40. This manufacturing method consists in preparing a solution consisting of a source of lithium and cobalt, acetic acid and 2-methoxyethanol. The film formed was smaller than 200 nm in thickness. The film was annealed at a temperature above 600° C. under oxygen. The solution was then deposited on the metal substrate by spin coating.

Many documents disclose sol-gel synthesis techniques that consist in preparing a powder from a gel, such as in particular the publications by Fey T. K. G. et al., Journal of Materials Chemistry and Physics, 2003, 79, 21-29; Fey T. K. G. et al., Journal of Materials Chemistry and Physics, 2004, 87, 246-255; and Hao Y. J. et al., Journal of Power Sources, 2006, 158, 1358-1364. These documents describe the preparation of starting sols from precursors dissolved in solvents with chelating agents. These sols are heated to form a gel that is then dried to obtain a solid that is then calcinated and implemented in powder form. Adhesion of the sols produced by these techniques to their carriers cannot be taken for granted. Preparation of LiCoO₂ by a sol-gel method is in particular known from Porthault et al., Journal of Power Sources, 2010, 195, 6262-6267. The sols are prepared in the presence of a source of lithium and cobalt, ethylene glycol or water and acrylic acid. Powder synthesis trials were carried out and thin films deposited by spin coating. The films obtained adhered badly to an Si/SiO₂/Pt substrate. Delamination of the deposited films was observed and only the powders produced by the sol-gel process could be analysed. As mentioned above, this publication demonstrates that results obtained and reported based on a solid in powder form do not make it possible to predict the behaviour of the same solid when it is implemented in the form of a film, or that the same solid will be sufficiently adherent to form a film on an SiO₂/Pt substrate.

The preparation of thin LiCoO₂ films by dip coating is also known from WO 02/091501. The LiCoO₂ films are prepared from a solution obtained by dissolving citric acid, lithium acetate and hydrated cobalt acetate in ethylene glycol. A good adherence of the LiCoO₂ film to the substrate is observed only when the roughness of the substrate is increased by treating the surface of the latter.

Deposition of sol-gels by spin coating is also known from Patil et al., Journal of Electroceram, 2009, 23, 214-218, in which the preparation of the sol implements precursors of lithium and cobalt in methanol with a non-disclosed amount of citric acid. Although these deposits adhere to their substrates, their purity after calcination at 750° C. is unsatisfactory, as in particular demonstrated by voltammetric cycling measurements (FIG. 5, page 217). Furthermore, the electrochemical properties of the deposited materials do not meet the necessary requirements for industrial applications such as microbatteries. Specifically, cyclic voltammetry of the LiCoO₂ must show the presence of three peaks corresponding to three separate reduction-oxidation processes located at 3.95 V, 4.06 V and 4.18 V. Only the first peak can be seen in the measurements disclosed in this document. Furthermore, the insertion capacity (FIG. 6, page 217) drops very rapidly to reach 80 mAh/g after 40 cycles.

Preparation of thin LiCoPO₄ films by sol-gel processing is also known from Bhuwaneswari M. S., Journal of Sol-Gel Sciences & Technology, 2010, 56, 320-326. The films are prepared in the presence of a source of lithium, cobalt and phosphate, ethylene glycol and citric acid and deposited on a substrate by dip coating. The reported results do not at the present time allow the deposit thus formed to be deployed industrially.

Thus, thin films prepared by sol-gel processing regularly exhibit problems with adherence to the substrates used. Cracks in the surface of the film are also observed. The manufacture of thin films by sol-gel processing may therefore be improved.

### BRIEF SUMMARY OF THE INVENTION

One of the aims of the present invention is to provide an improved process for manufacturing transition metal oxide films, allowing homogeneous crack-free films that have good electrochemical properties and adhere well to their substrates to be obtained.

According to a first aspect, the invention provides a method for manufacturing transition metal oxide films of formula AₐM_{b}Z_{c}O_{d}, in which:

A is an alkali or alkaline-earth metal or a mixture of alkali or alkaline-earth metals, A preferably being an alkali metal and A advantageously being chosen from the group consisting of Li, Na and K, and their mixtures;
M is a metal or a mixture of metals chosen from the transition metals, lanthanides or actinides;
Z is a chemical element or a mixture of chemical elements chosen from columns 13 to 15 of the periodic table and preferably Z is P or B;
O is oxygen;
c is a real number higher than or equal to 0; and a, b and d are real numbers higher than 0; and a, b, c, and d are chosen so as to ensure electroneutrality;
said method comprises the steps of:
a) preparing a solution comprising one or more precursors, preferably two or more than two precursors, containing one or more of the elements A, M, Z and O, a chelating agent chosen from aliphatic carboxylic di- or triacids comprising 2 to 20 carbon atoms and salts or mixtures thereof, and a polar organic solvent having a boiling point at atmospheric pressure below 150° C.;
b) forming a sol by stirring said solution; and
c) implementing said sol in the form of said transition metal oxide film, characterised in that
said sol is implemented by:
c′) depositing one or more layers of said sol on a substrate; and
c″) preparing said transition metal oxide film by calcinating said one or more layers formed in step c′) at a calcination temperature comprised between 250° C. and 725° C.

Preferably, the method relates to the manufacture of thin transition metal oxide films. The term “thin” such as used here relates to the average thickness of said transition metal oxide film, said average thickness being smaller than 250 μm. The film may be flat, raised, crenellated or stepped.

Preferably, the present method relates to the manufacture of transition metal oxide films, advantageously lithiated transition metal oxide films i.e. films containing lithium.

According to another aspect of the invention, a transition metal oxide film prepared according to the present invention may be used as an electrode material, preferably as an electrode material in a microbattery with an insertion capacity higher than or equal to 60%, advantageously higher than or equal to 70%, preferably higher than or equal to 80% and in particular higher than or equal to 90% of the theoretical reversible insertion capacity. Preferably, the capacity per unit weight of said film after 20 cycles is at least higher than 70% of the theoretical capacity per unit weight. Preferably after 100 cycles, its capacity per unit weight is at least higher than 65% of its theoretical capacity per unit weight.

### BRIEF DESCRIPTION OF THE SEVERAL VIEWS OF THE DRAWINGS

FIG. 1 shows the galvanostatic cycling curve of an LiCoO₂ film prepared according to one particular embodiment of the present invention.

FIG. 2 shows the X-ray diffraction (XRD) pattern of a film of LiCoO₂ prepared according to one particular embodiment of the present invention.

FIGS. 3a and 3b show cyclic voltammetry and voltammetric cycling of an LiCoO₂ film prepared according to one particular embodiment of the invention, respectively, illustrating, on the one hand, the variation in the specific capacity of the electrode as a function of the number of charge and discharge cycles, and on the other hand, the variation in the current as a function of potential.

FIG. 4 shows the charge and discharge capacities of an LiCoO₂ film prepared according to one particular embodiment of the invention as a function of the number of charge and discharge cycles undergone by the electrode.

FIG. 5 shows the cyclic voltammetry of an Li₄Mn₅O₁₂ film prepared according to one particular embodiment of the present invention.

### DETAILED DESCRIPTION OF THE INVENTION

According to a first aspect, the present invention relates to a method for manufacturing transition metal oxide films of formula AₐM_{b}Z_{c}O_{d}, in which:

A is an alkali or alkaline-earth metal or a mixture of alkali or alkaline-earth metals, A advantageously being an alkali metal and A preferably being chosen from the group consisting of Li, Na and K, and their mixtures, A in particular being Li;
M is a metal or a mixture of metals chosen from the transition metals, lanthanides or actinides, M preferably being a transition metal or a mixture of transition metals chosen from the elements of columns 3 to 12 of the periodic table, M preferably being chosen from the group consisting of Co, Ni, Mn, Fe, Cu, Ti, Cr, V and Zn, and their mixtures;
Z is a chemical element or a mixture of chemical elements chosen from columns 13 to 15 of the periodic table and advantageously Z is chosen from the group consisting of B, N, P, Al, Si, Ge, In, Sn and Ga and preferably Z is P or B;
O is oxygen;
c is a real number higher than or equal to 0; a, b and d are real numbers higher than 0; and a, b, c and d are chosen so as to ensure electroneutrality.
Said method furthermore comprises the following steps:
a) preparing a solution comprising one or more, preferably two or more than two, precursors containing one or more of the elements A, M, Z and O, a chelating agent and a polar organic solvent;
b) forming a sol by stirring said solution, preferably at room temperature; and
c) implementing said sol in the form of said transition metal oxide film, the chelating agent being chosen from aliphatic carboxylic di- or tri-acids comprising 2 to 20 carbon atoms and salts or mixtures thereof, and said polar organic solvent having a boiling point at atmospheric pressure below 150° C.

Implementation of the sol in the form of said transition metal oxide film may comprise steps of:
c′) depositing one or more layers of said sol on a substrate; and
c″) preparing said transition metal oxide film by calcinating said one or more layers formed in step c′).

When a plurality of layers of said sol are formed on a substrate, the calcination carried out in step c″) may be carried out after each of the layers of said sol is deposited or after a plurality of layers of said sol have been deposited.

Said calcination (step c″) of the present method is carried out at a calcinating temperature comprised between 250° C. and 800° C., advantageously between 250° C. and 725° C., preferably between 250° C. and 700° C., more preferably between 250° C. and 650° C., in particular between 300° C. and 580° C., and more particularly between 350° C. and 550° C. The calcinating step may be carried out each time a layer of said sol is deposited, i.e. each time step c′) is carried out, or after a plurality of layers have been deposited in succession. Said one or more layers are kept at the calcinating temperature for a time comprised between 30 seconds and 1 hour and preferably between 5 minutes and 30 minutes. The calcinating step c″) allows organic compounds to be removed and the desired metal oxide film to be obtained.

In particular, the transition metal oxide may be of formula AₐM_{b}Z_{c}O_{d}, in which c is 0. The transition metal oxide may be of formula AaMbOd in which A is an alkali metal and advantageously A is chosen from the group consisting of Li, Na and K, in particular A is Li;

M is chosen from the group consisting of Co, Ni, Mn, Fe, Cu, Ti, Cr, V and Zn and their mixtures;
O is oxygen;
a, b and d are real numbers higher than 0 and chosen so as to ensure electroneutrality.

Surprisingly, it has been observed that specific and combined use of a chelating agent and polar organic solvent such as described in the present invention makes it possible to facilitate the adherence of the film prepared according to the present invention to a substrate. In addition, the use of a chelating agent makes it possible to limit considerably, or prevent, the presence of cracks, defects or asperities on the surface of said film prepared according to the present invention. Furthermore, the polar organic solvent having a low boiling point, i.e. below 150° C. and preferably below 100° C., ensures satisfactory wetting of the substrate by said sol formed in step b). The surface of said film prepared according to the present invention may possess a low roughness, advantageously lower than 2000 nm, preferably lower than 1000 nm and in particular lower than 500 nm. Preferably, said transition metal oxide film may be deposited on a substrate. Thus, when said transition metal oxide film may be deposited on a substrate, the roughness of the surface of said film includes the roughness due to the surface of said substrate. When said transition metal oxide film is deposited on a substrate, the surface of said film prepared according to the present invention may possess a low roughness, advantageously lower than 2500 nm, preferably lower than 1200 nm and in particular lower than 520 nm. In particular, the method according to the invention makes it possible to ensure the formation of said transition metal oxide film and its adherence to substrates of low roughness, in particular substrates having a surface exhibiting a roughness Ra lower than 500 nm.

According to one preferred embodiment, said solution prepared in step a) also comprises a stabilising agent chosen from the group consisting of water or a carboxylic acid comprising 1 to 20 carbon atoms or a salt of said acid or a mixture thereof. The stabilising agent is different from the chelating agent. Said carboxylic acid is therefore preferably a monoacid, preferably an aliphatic monoacid. The carboxylic acid may be methanoic acid, acetic acid, propanoic acid, butanoic acid, pentanoic acid, hexanoic acid, octanoic acid, nonanoic acid and decanoic acid. In particular, the stabilising agent may be water, acetic acid, propanoic acid, butanoic acid or pentanoic acid. The stabilising agent makes it possible to prevent precipitation of alkali and/or metal ions originating from said one or more precursors used in step a) of the present method. The stabilising agent thus allows the quality of the solution to be maintained and controlled between its preparation and its implementation (steps b), c″) and c″) of the present method).

The proportion of stabilising agent in the solution prepared in step a) may be comprised between 0.1 and 30% and preferably between 1 and 20% of the amount of solvent by weight.

Preferably, the chelating agent is chosen from aliphatic di- or tri carboxylic acids comprising 2 to 20 carbon atoms, advantageously 2 to 12 carbon atoms and preferably 2 to 10 carbon atoms, their salts or their mixtures. In particular, the chelating agent may be a dicarboxylic acid chosen from the group consisting of oxalic, malonic, succinic, glutaric, adipic, maleic, fumaric, pimelic, suberic, azelaic, sebacic, glutaconic and itaconic acid and salts and mixtures thereof. Preferably, the tricarboxylic acid may be citric acid, isocitric acid, aconitic acid, propane-1,2,3-tricarboxylic acid or oxalosuccinic acid; in particular the tricarboxylic acid is citric acid.

Preferably, the chelating agent is chosen from oxalic acid, succinic acid or adipic acid or citric acid or a salt thereof, or mixtures thereof. In particular, the chelating agent is adipic acid or a salt of said acid. The use of these acids alone or in combination allows said sol to be formed without recourse to a step of heating the solution or to a controlled atmosphere. The method for manufacturing said transition metal oxide film is thus optimised. In addition, said film thus prepared adheres well to its substrate, which is preferably made of metal and/or compatible with the envisaged applications.

The proportion of chelating agent in the solution prepared in step a) may be comprised between 0.1 and 5 equivalents, advantageously between 0.5 and 3 equivalents, preferably between 0.8 and 1.2 equivalents and is in particular 1 equivalent of the sum of the amounts, expressed in moles, of the one or more precursors of A and M used in the solution prepared in step a), divided by the number of acid functions of the chelating agent.

As mentioned above, the polar organic solvent has a boiling point at atmospheric pressure below 150° C. and preferably below 100° C. The expression “organic solvent” refers to an organic compound or a mixture comprising at least 80% by weight, preferably 90% by weight and in particular 99% by weight of an organic compound. Said organic compound comprises at least one carbon atom bonded to a hydrogen atom. An organic solvent is said to be “polar” if the organic compound has a dipole moment larger than 0.5 debye. The polar organic solvent is preferably chosen for its ability to dissolve the chelating agent, the stabilising agent and the precursors. The solvent is chosen depending on the precursors to be dissolved. Advantageously, the polar organic solvent may be chosen from methanol, ethanol, propan-1-ol, isopropanol, butanol, pentanol, acetone, butanone, tetrahydrofuran, acetonitrile, diethyl ether, dichloromethane, chloroform, dioxane, 2-methoxyethanol and ethyl acetate. Preferably, the polar organic solvent may be methanol, ethanol, isopropanol, butanol or tetrahydrofuran.

Said one or more precursors containing one or more of the elements A, M, Z and O may be salts, hydroxides, oxides or complexes of transition metals, lanthanides or actinides; or salts, hydroxides, oxides or complexes of alkali or alkaline-earth metals; or salts, hydroxides or oxides comprising a chemical element or a mixture of chemical elements chosen from columns 13 to 15 of the periodic table. The expression “periodic table” relates to the Periodic Table of the Elements. The expression “one or more” such as used here is understood to mean 1, at least 1, more than 1, or 1, 2 or more than two; or 1 or two or more and preferably two or more. The expression “transition metals” refers to the elements of columns 3 to 12 of the periodic table.

Advantageously, said one or more, preferably two or more than two, precursors containing one or more of the elements A, M, Z and O are selected from the group consisting of salts or hydroxides of lithium, sodium, potassium, cobalt, nickel, manganese, iron, copper, titanium, chromium, vanadium and zinc and salts of phosphoric acid, boric acid or a derivative of the latter, and their mixtures. The expression “salts of phosphoric acid” encompasses, apart from phosphoric acid and polyphosphoric acid, salts of calcium phosphate, sodium phosphate, potassium phosphate or ammonium phosphate. The expression “boric acid or a derivative of the latter” encompasses, apart from boric acid, borate salts and borate esters. The salts of lithium, sodium, potassium, cobalt, nickel, manganese, iron, copper, titanium, chromium, vanadium and zinc may be nitrate, acetate, oxalate, citrate, succinate, carbonate or adipate salts. The proportions of each of the precursors may be set so as to obtain the desired transition metal oxide.

Said one or more precursors may comprise a first precursor chosen from a salt or hydroxide of lithium, sodium or their mixture, and a second precursor chosen from a salt or hydroxide of cobalt, nickel or manganese or their mixture. The molar ratio of said first precursor to said second precursor may be comprised between 10:1 and 1:10, advantageously between 2:1 and 1:2, the molar ratio in particular being 1. Said one or more precursors may comprise a third precursor chosen from salts of phosphoric acid, or boric acid or a derivative of the latter. Advantageously, the third precursor is a salt of ammonium phosphate. Preferably, the molar ratio of the first precursor to the third precursor may be comprised between 10:1 and 1:10 and advantageously between 2:1 and 1:2, in particular the molar ratio is 1. Preferably, the molar ratio of the second precursor to the third precursor may be comprised between 10:1 and 1:10 and advantageously between 2:1 and 1:2, in particular the molar ratio is 1. In particular, the molar ratio of the first precursor to the second and third precursors may be 1:1:1.

In particular, said one or more precursors comprise a salt or hydroxide of lithium, preferably a lithium acetate or nitrate salt, and a salt of cobalt, nickel and/or manganese, preferably an acetate, adipate, oxalate, succinate or nitrate salt of cobalt, nickel and/or manganese. According to one preferred embodiment, said one or more precursors comprise lithium acetate and cobalt acetate. Alternatively, one of said one or more precursors may be an adipate, oxalate or succinate salt. Using an adipate, oxalate or succinate salt as a precursor makes it possible to provide, simultaneously, some of the amount of the chelating agent and one or more of the elements A, M or Z required to prepare the solution in step a) of the present method. For example, cobalt adipate may be used.

Said solution prepared in step a) may also contain electrically conductive particles such as particles of silver, gold, indium and platinum, carbon fibres, carbon nanoparticles or carbon nanotubes.

According to one preferred embodiment, step b) is carried out under ambient pressure and temperature conditions. Step b) may also be carried out under ambient atmosphere, i.e. under an atmosphere that is neither controlled nor modified relative to ambient air.

According to one preferred embodiment, the sol formed in step b) has a viscosity lower than 100 centipoises (0.1 Pa·s), preferably lower than 50 centipoises (0.05 Pa·s) and in particular lower than 10 centipoises (0.01 Pa·s). Producing a sol having the aforementioned viscosity allows the preparation of said transition metal oxide film and its deposition on the substrate to be improved. Alternatively, when the chelating agent is citric acid or a salt thereof, the sol formed in step b) may have a viscosity higher than 100 centipoises (0.1 Pa·s). Preferably, the sol may have a good homogeneity, in particular when the solution of step a) does not contain electrically conductive particles such as defined above, i.e. when no electrically conductive particles such as defined above are added during the preparation of the solution a). In particular, the sol according to the present invention is considered to be homogeneous when it does not contain particles that are larger than 2 μm, advantageously larger than 1 μm, preferably larger than 0.5 μm and in particular larger than 0.2 μm, in size.

Preferably, the deposition of one or more layers of said sol on a substrate is carried out on a substrate having a temperature apt to evaporate said polar organic solvent, advantageously a temperature close to the boiling point of said polar organic solvent. The expression “close to” such as used here corresponds to a temperature range the lower limit of which is equal to 30° C. below the boiling point of said polar organic solvent and the upper limit of which is equal to 10° C. above the boiling point of said polar organic solvent. Thus, the polar organic solvent present in the sol is at least partially evaporated before another layer of said sol is deposited. The quality of the resulting film is improved.

Preferably, said substrate is a metal substrate. In particular, said substrate may be an electrically conductive substrate. The substrate may comprise carbon, platinum, gold, stainless steel, platinum on SiO₂, ITO (indium tin oxide), platinum on a silicon wafer, or metal alloys comprising at least two elements chosen from nickel, chromium and iron. Said metal alloys may also comprise other elements chosen from molybdenum, niobium, cobalt, manganese, copper, aluminium, titanium, silicon, carbon, sulphur, phosphorus or boron. By way of example, the metal alloys may be Ni₆₁Cr₂₂Mo₉Fe₅, Ni₅₃Cr₁₉Fe₁₉Nb₅Mo₃, Ni₇₂Cr₁₆Fe₈, Ni₅₇Cr₂₂Co₁₂Mo₉, Ni_{32.5}Cr₂₁Fe or Ni₇₄Cr₁₅Fe₇Ti_{2.5}Al_{0.7}Nb_{0.95}, said alloys may furthermore contain traces or small amounts of one of the following components: molybdenum, niobium, cobalt, manganese, copper, aluminium, titanium, silicon, carbon, sulphur, phosphorus or boron. For example, said metal alloys may be Inconel® type alloys.

Said sol may be deposited on the substrate (step c′) by spin coating, dip coating or spray coating or slide coating or screen printing or inkjet printing or roll coating. Preferably, when the viscosity of the sol formed in step b) has a viscosity lower than 100 centipoises (0.1 Pa·s), preferably lower than 50 centipoises (0.05 Pa·s), in particular lower than 10 centipoises (0.01 Pa·s), step c) or c′) is carried out by spray coating. Preferably, when the implementation of said sol in the form of said transition metal oxide film on the substrate (step c) is carried out by spray coating, the present invention makes it possible to prevent sagging, which is especially disadvantageous in the context of masked deposition in terms of product quality.

The substrate on which the sol is deposited to form said transition metal oxide film may be smooth or have a low roughness. The present method is particularly effective at forming or depositing a transition metal oxide film on a smooth or low-roughness substrate. The film thus formed adheres well to the substrate, in contrast to prior-art wet processing methods with which the film deposited on the metal substrate exhibits poor adherence to a smooth or low-roughness substrate. In one preferred embodiment, the preferably metal substrate may have an Ra roughness lower than 500 nm, preferably lower than 200 nm and more preferably lower than 20 nm.

The transition metal oxide film according to the present invention may have a monolayer or multilayer structure depending on the number of layers deposited in step c′). A transition metal oxide film having a multilayer structure may be prepared by repeating step c′) of the present method. Each step c′) may be followed by implementation of the step c″) of calcinating the layer formed at a temperature comprised between 250° C. and 800° C., advantageously between 250° C. and 725° C., preferably between 250° C. and 700° C., more preferably between 250° C. and 650° C. and in particular between 300° C. and 580° C. Each layer of the multilayer structure may be independent of the others. Thus, each layer may have the same composition, i.e. consist of the same transition metal oxide or oxides of formula AₐM_{b}Z_{c}O_{d} such as described in the present invention. For example, a multilayer film of transition metal oxide such as LiCoO₂ could be formed by successive depositions on the substrate, i.e. by repeating step c′) one or more times until the desired multilayer structure has been obtained.

Alternatively, a film of multilayer structure may be formed by depositing in succession one or more layers of different sols. Each sol may be independently prepared from a solution comprising a different chelating agent and/or polar organic solvent. Preferably, said one or more precursors containing one or more elements A, M, Z and O, are identical in each of the prepared sols. Said multilayer film may be prepared by repeating step c′) using the different prepared sols until the desired multilayer structure has been obtained.

Alternatively, a film of multilayer structure may be formed by depositing in succession one or more layers of different sols prepared using a solution, comprising said one or more precursors, containing one or more different elements A, M, Z and O, and optionally a different chelating agent and/or polar organic solvent. Said multilayer film may be prepared by repeating steps a) to c′) until the desired multilayer structure has been obtained. For example, a first layer could comprise LiCoO₂; additional layers, deposited before or after this first layer on the substrate, could irrespectively comprise, for example LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{1/3}Mn_{1/3}Co_{1/3}O₂, LiNi_{0.8}Co_{0.2}O₂, LiNi_{0.5}Mn_{1.5-z}Ti_{z}O₄ where z is a number between 0 and 1.5, LiMn₂O₄, LiMnO₂, Li₄Mn₅O₁₂, LiNiO₂, LiFePO₄, Li₄Mn₅O₂, LiₓCoPO₄ where x is a number which may be 0.90, 0.95, 1 or 1.05, LiMnPO₄ or Li₄Ti₅O₁₂.

A transition metal oxide film having a multilayer structure may comprise between 2 and 200 layers and preferably between 2 and 100 layers. Each layer may have a thickness comprised between 0.01 and 2.5 μm independently of one another. Each deposition of one or more layers of said sol on a substrate may be carried out by spray coating.

The transition metal oxide film according to the present invention may have an average thickness comprised between 0.01 μm and 250 μm, preferably between 0.1 and 50 μm, preferably between 1 and 30 and preferably between 0.5 and 10 μm.

Preferably, a heat treatment for drying one or more of said layers deposited in step c′) may be carried out. This heat treatment may be carried out each time a layer is deposited, i.e. each time step c′) is carried out, or after a plurality of layers have been deposited in succession (i.e. after step c′) has been repeated a plurality of times), or when the film formed has a thickness comprised between 1 and 2.5 μm. The heat treatment is carried out at a temperature below 250° C. and advantageously below 150° C. and preferably below 70° C. The heat treatment may be carried out at atmospheric pressure or under vacuum. The heat treatment allows the polar organic solvent used in the present method to be evaporated.

The present method may furthermore comprise a step d) of annealing said transition metal oxide film at an annealing temperature comprised between 300° C. and 750° C., advantageously between 300° C. and 700° C., preferably between 300° C. and 600° C. and in particular between 350° C. and 550° C. Preferably, in step d), said transition metal oxide film is kept at the annealing temperature for a time comprised between 30 minutes and 12 hours and preferably between 1 hour and 10 hours. This anneal promotes more complete formation of a particular crystal form of the transition metal oxide. The particular crystal form is that that may allow said transition metal oxide film according to the present invention to achieve a capacity per unit weight such as mentioned in the present application. For example, FIG. 2 shows the X-ray diffraction (XRD) pattern of an LiCoO₂ film the preparation method of which contains an annealing step carried out at 700° C. for 3 hours.

The transition metal oxide film of formula AₐM_{b}Z_{c}O_{d} such as defined above and obtained by steps a) to c″) or a) to d) of the present method may be chosen from the group consisting of LiCoO₂, LiMnO₂, LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{1/3}Mn_{1/3}Co_{1/3}O₂, LiNi_{0.8}Co_{0.2}O₂, LiNi_{0.5}Mn_{1.5-z}Ti_{z}O₄ where z is a number between 0 and 1.5, LiMn₂O₄, Li₄Mn₅O₁₂, LiNiO₂, LiFePO₄, LiₓCoPO₄ where x is a number which may be 0.90, 0.95, 1 or 1.05, LiMnPO₄ and Li₄Ti₅O₁₂. Advantageously, the transition metal oxide film of formula AₐM_{b}Z_{c}O_{d} such as defined above may be LiCoO₂, LiMnO₂, LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{1/3}Mn_{1/3}Co_{1/3}O₂, LiNi_{0.8}Co_{0.2}O₂, LiMn₂O₄, Li₄Mn₅O₁₂, LiNiO₂, Li₄Ti₅O₁₂; preferably LiCoO₂, LiMnO₂, LiMn₂O₄, Li₄Mn₅O₁₂, LiNiO₂ or Li₄Ti₅O₁₂.

The method according to the invention allows a transition metal oxide film to be deposited such that the capacity per unit weight of the material is at least 60%, advantageously higher than 70%, preferably 80% and in particular higher than 90% of the theoretical reversible specific capacity of said material. In the particular case of an LiCoO₂ film, the theoretical capacity per unit weight is higher than 90 mA·h/g, advantageously higher than 100 mA·h/g and preferably comprised between 100 and 137 mA·h/g; the theoretical capacity per unit weight is determined in the first discharge cycle. Preferably, the capacity per unit weight of said transition metal oxide film after more than 20 discharge cycles is at least higher than 70% of the theoretical capacity per unit weight. Preferably, the capacity per unit weight of said transition metal oxide film after more than 100 discharge cycles is at least higher than 65% of the theoretical capacity per unit weight measured in a C/10 regime. The theoretical reversible specific capacity is widely accepted as being half the theoretical amount of ions that may be inserted into or extracted from one gram of electrode material. In the case of LiCoO₂, the theoretical reversible specific capacity is 137 mAh/g.

According to a second aspect of the invention, a sol is provided. Said sol comprises one or more precursors, preferably two or more than two precursors, such as defined in the present invention, a chelating agent chosen from di- or tri-aliphatic carboxylic acids comprising 2 to 20 carbon atoms and salts or mixtures thereof, and a polar organic solvent having a boiling point at atmospheric pressure below 150° C.

Thus, said sol may comprise:
one or more precursors containing one or more of the elements A, M, Z and O selected from the group consisting of the salts or hydroxides of lithium, sodium, potassium, cobalt, nickel, manganese, iron, copper, titanium, chromium, vanadium, zinc, and the salts of phosphoric acid, boric acid or a derivative of the latter, and their mixtures;
a chelating agent chosen from aliphatic di- or tricarboxylic acids comprising 2 to 20 carbon atoms and salts or mixtures thereof; and
a polar organic solvent having a boiling point at atmospheric pressure below 150° C.

Advantageously, when the chelating agent is chosen from dicarboxylic acids, the latter may be oxalic, malonic, succinic, glutaric, adipic, maleic, fumaric, pimelic, suberic, azelaic, sebacic, glutaconic and itaconic acid and the salts and mixtures thereof. Preferably, the tricarboxylic acid may be citric acid, isocitric acid, aconitic acid, propane-1,2,3-tricarboxylic acid or oxalosuccinic acid; in particular, the tricarboxylic acid is citric acid.

In particular, said sol comprises:
a salt or hydroxide of lithium or sodium, or their mixture;
a salt or hydroxide of cobalt, nickel, titanium, chromium or manganese, or their mixture;
adipic acid or succinic acid or a salt of said acids; and
a polar organic solvent having a boiling point at atmospheric pressure below 150° C.
   Preferably, said sol comprises a lithium salt, a cobalt salt, adipic acid or a salt of said acid and a polar organic solvent having a boiling point at atmospheric pressure below 150° C. Said sol advantageously has a viscosity lower than 100 centipoises (0.1 Pa·s), preferably lower than 50 centipoises (0.05 Pa·s) and in particular lower than 10 centipoises (0.01 Pa·s). Said sol allows transition metal oxide films to be prepared. Said films adhere well to metal substrates and may therefore advantageously be used as an electrode material, for example in microbatteries. Preferably, the sol may also contain a stabilising agent. The stabilising agent may be chosen from the group consisting of water or a carboxylic acid comprising 1 to 20 carbon atoms or a salt of said acid or a mixture thereof. The stabilising agent is different from the chelating agent. Said carboxylic acid is therefore preferably a monoacid, preferably an aliphatic monoacid. The carboxylic acid may be methanoic acid, acetic acid, propanoic acid, butanoic acid, pentanoic acid, hexanoic acid, octanoic acid, nonanoic acid and decanoic acid. In particular, the stabilising agent may be water, acetic acid, propanoic acid, butanoic acid and pentanoic acid. The proportion of stabilising agent in the sol may be comprised between 0.1 and 30% and preferably between 1 and 20% of the amount by weight of solvent contained in the sol. In particular, the sol according to the present invention may be homogeneous, i.e. not contain any particles in suspension, and preferably any particles larger than 2 μm, advantageously larger than 1 μm, preferably larger than 0.5 μm and in particular larger than 0.2 μm, in size.

As mentioned above, the transition metal oxide film such as described in the present invention may be used as an electrode material, preferably as a positive electrode material. Said electrode may thus be used in a microbattery. Preferably, the transition metal oxide film according to the present invention, when it is used as an electrode material, is obtained by steps a) to c) or a) to c″) or a) to d) of the method according to the present invention. The transition metal oxide film such as described in the present invention may be used in a fuel cell stack. The transition metal oxide film according to the present invention may be used as a material for protecting an electrode material, preferably in fuel cell stacks. Thus, said transition metal oxide film may be deposited on all or some of the surface of an anode or cathode.

### EXAMPLES

### General Protocol for Preparing a Transition Metal Oxide Film According to the Present Invention

First, a starting solution is prepared. To do this, the transition metal precursors are mixed then the amount of solvent required to dissolve the precursors is added. The amount of solvent may be increased in order to adjust as desired the viscosity of the solution. The solution is stirred for 1 hour at ambient temperature (between 20 and 25° C.), pressure and under ambient atmosphere. After 1 hour the stabilising agent and the chelating agent are added. These two additions are made under stirring and at ambient temperature and pressure and under ambient atmosphere. The stirring is continued for 12 hours in order to allow a sol to form.

Preparation of the transition metal oxide film from the sol prepared beforehand.

The sol is sprayed onto a preferably metal substrate under ambient atmosphere. The flow rate in the injection head (Nordson, model EFD 781) of the spraying device is 0.12 g to 0.16 g of solution per second (for a solution having a viscosity lower than 0.1 Pa·s) and the lateral velocity of said solution is 50 cm/s. The amount of material projected onto the substrate may depend on the concentration of the sol or on the above parameters. Generally, films of 0.1 to 0.2 μm thickness are prepared on each pass. A number of passes may be carried out in order to achieve the desired thickness. The film is dried under vacuum at 60° C. (1 h), then calcinated under air (uncontrolled atmosphere). Once the thickness desired for the film is achieved, a final anneal is optionally carried out.

Procedure for Determining Roughness.

The Ra roughness of the surfaces corresponds to the arithmetic mean of the absolute values of the divergence of the profile from the average of this profile, it is expressed in microns. It was measured by means of a Dektak contact profilometer (supplier Bruker) the stylus of which had a radius of curvature of 12.5 microns.

Procedure for Determining Viscosity.

Viscosity, expressed in Pa·s or in centipoise, is measured using a Brookfield LVDVE viscosimeter.

Procedure for Determining Adherence.

Adherence is measured after implementation of said sol in the form of said transition metal oxide film. Thus, the adherence may be measured after implementation in step c) of depositing one or more layers, preferably after said heat treatment; after implementation of the calcinating step c″); or after step d) of annealing said transition metal oxide film. Adherence is first measured by simply inclining the substrate once it has been covered with one or more layers of said sol (step c′). Said one or more deposited layers are considered to have adhered to the substrate if they do not deteriorate under the effect of the inclination. A rubbing test is then carried out and consists in passing a finger or a dry cloth over the substrate covered with said transition metal oxide film, i.e. after calcination (step c″). Visual inspection of the coated substrate allows the measure of the adherence of the coating to be evaluated. A coating was defined as being adherent to the substrate when at least one layer of said transition metal oxide film remained on the substrate.

Procedure for Determining Material Electrochemical Performance.

Material electrochemical performance is evaluated by galvanostatic-mode cycling measurements with potential limitation. The capacity per unit weight of the material is evaluated by integrating the current flowing through the material during each charge (or discharge) cycle and dividing by the deposited weight.

Procedure for Determining Material Purity.

Material purity may be evaluated by X-ray diffraction (XRD) and by cyclic voltammetry in which current is measured as a function of increments of potential.

Procedure for Determining the Homogeneity of a Formulation Such as a Sol.

The homogeneity of a formulation such as a sol is evaluated by observing whether the formulation is transparent or not with the naked eye. A formulation is furthermore filtered with a 0.2 micron filter (PALL nylon acrodisc). The filtrate is thus considered to be homogeneous.

### Example 1

### Preparation of a Film of LiCoO₂ According to the Invention

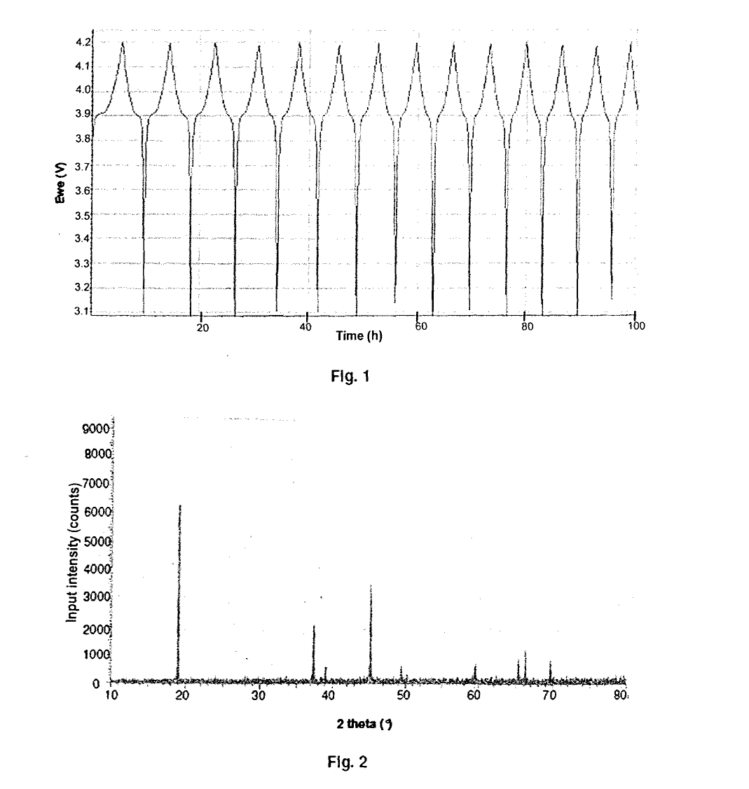

The solution is prepared by mixing 2 g of CoAc₂.4H₂O (hydrated cobalt acetate) and 0.53 g of lithium acetate, to which 15 ml of methanol are added. The amount of methanol was enough to allow the cobalt and lithium salts to be dissolved. The latter are in equimolar amounts. The solution is stirred for 1 hour at room temperature (between 20 and 25° C.). After 1 hour, 2 ml of concentrated (96%) acetic acid then 0.85 g of adipic acid are added. These two additions are carried out under stirring and at ambient temperature. The stirring is continued for 12 hours in order to allow the sol to form. The sol is deposited by spraying onto a metal substrate (SiO₂/TiO₂/Pt), raised to a temperature close to 80° C. On each pass a film of a thickness of 0.1 to 0.2 μm is produced. After 10 passes, the film possesses a thickness of 1 to 2 μm. Every 10 passes, the film is dried under vacuum at 60° C. (1 h), then calcinated under air (uncontrolled atmosphere) for 15 minutes at 540° C. Once the desired thickness of the film is achieved, a final anneal of 2 h at a temperature of 540° C. is carried out. The LiCoO₂ film adheres well to the substrate. FIG. 1 shows the galvanostatic cycling curve of an LiCoO₂ film prepared according to example 1. An initial discharge capacity per unit weight of 112 mAh/g is calculated for the first cycle and of 99 mAh/g for the fifth cycle.

### Example 2 (Invention)

Example 1 is repeated substituting ethanol (25 ml) for methanol (15 ml). Good adhesion of the LiCoO₂ film to the substrate used (SiO₂/TiO₂/Pt) is observed.

### Example 3 (Invention)

Example 1 is repeated substituting water (0.5 ml) for the acetic acid. The metal substrate is made of steel. Good adhesion of the LiCoO₂ film to the substrate is observed.

### Example 4 (Invention)

Example 1 is repeated without adding a stabilising agent, i.e. without adding acetic acid. The amount of solvent was set to 25 ml. Good adhesion of the LiCoO₂ film to the substrate (SiO₂/TiO₂/Pt) is observed.

### Example 5 (Invention)

Example 1 is repeated without adding a stabilising agent, the 5 or 10% of adipic acid being substituted by an equivalent amount of citric acid; the term “equivalent” here must be understood to mean a molar amount having an identical number of acid functions. The LiCoO₂ film adheres correctly to the metal substrate (SiO₂/TiO₂/Pt).

### Example 6 (Invention)

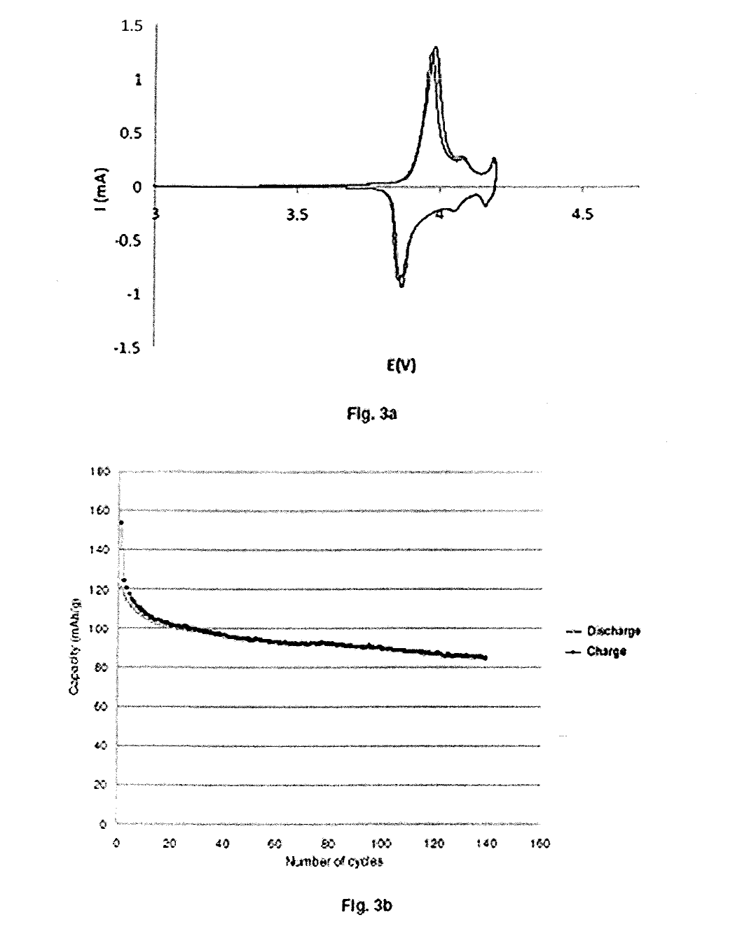

A solution is prepared by mixing 4.68 g of Co(NO₃)₂.6H₂O (cobalt nitrate hexahydrate) and 1.06 g of lithium acetate, to which 50 ml of ethanol is added. Once the solution is transparent, 4 ml of acetic acid (stabilising agent) and 1.7 g of adipic acid (chelating agent) are added. A steel substrate is covered by spray coating 72 layers of solution interspersed with a plurality of sequences of heat treatments or calculation treatments at 540° C., then is next annealed for 6 h at 540° C. in order to form an electrode. The electrochemical performance of the electrodes thus prepared is illustrated in FIGS. 3a and 3b. FIGS. 3a and 3b show voltammetric cycling and cyclic voltammetry of the LiCoO₂ film deposited on the electrode, respectively. It demonstrates good crystallisation of the LiCoO₂. The voltammetric cycling unambiguously shows the presence of three redox peaks at 3.95 V, 4.06 V and 4.18 V. FIG. 3b shows curves of charge and discharge capacity as a function of the number of cycles undergone by the electrode. From this figure it may be deduced that the specific insertion capacity is 80% of the theoretical specific capacity (137 mA·h/g) after 5 cycles, higher than 70% after 20 cycles and 65% after 100 cycles.

### Example 7 (Comparative)

Example 1 is repeated substituting acrylic acid (0.88 ml) for the adipic acid. The roughness of the film increases during drying. The film precipitates on the electrode.

### Example 8 (Comparative)

A solution is prepared by dispersing 0.53 g of lithium acetate (LiAc) and 2 g of cobalt acetate (Co(Ac)₂.4H₂O) in 8 ml of water. 1.1 ml of acrylic acid is subsequently added. The amount of water added is the minimum amount required to dissolve the precursors and the acrylic acid. The amount of acrylic acid is equimolar relative to the amount of metal ions (Li+Co). The wettability of the solution is poor on metal substrates; in particular on platinum. The films are of very irregular thickness, with a roughness visible to the naked eye. The films are difficult to dry and bubbles appear during calcination. The adherence of the film to the metal substrate is poor or even non-existent.

### Example 9 (Comparative)

Example 8 is repeated replacing the water with ethylene glycol. The high viscosity of the solution, due to the viscosity of the ethylene glycol, hinders implementation of the spray deposition technique. The wettability of the solution on the substrate is poor. Inhomogeneous films of very variable thickness invariably result. The adherence of the film to the substrate is poor.

Table 1 below details the data and results of examples 1 to 9 such as described above. The specific use of a chelating agent according to the present invention and of a polar organic solvent according to the present invention allows thin transition metal oxide films to be prepared that adhere sufficiently to the substrate on which said films are deposited. The comparative examples demonstrate that the use of water as the solvent of the precursors or acrylic acid as the chelating agent considerably decreases the ability of the film to adhere to a substrate such as platinum. The specific combination of a chelating agent and a polar organic solvent such as provided according to the present invention furthermore allows transition metal oxide films to be prepared that are suitable for use as an electrode material, more particularly as cathode materials.

TABLE 1
Data relating to the formation of a transition metal oxide film and its adhesion to a
substrate

| | | | | | Wettability of | | | Adherence | Capacity |
|---|---|---|---|---|---|---|---|---|---|
| | | | | | the solution | | | after | per unit |
| | | Chelating | Stabilising | | on the | Calcination | Anneal | calcination | weight |
| Precursors | Solvent | agent | agent | Substrate | substrate | (T ° C.) | (T ° C.) | and anneal | (mAh/g) |
| LiAc + | methanol | Adipic | Acetic | SiO₂/TiO₂/Pt | Good | 540 | 540 | Yes | 105-115 |
| Co(Ac)₂•4H₂O | | acid | acid | | | | | | |
| LiAc + | ethanol | Adipic | Acetic | SiO₂/TiO₂/Pt | Good | 540 | 540 | Yes | — |
| Co(Ac)₂•4H₂O | | acid | acid | | | | | | |
| LiAc + | methanol | Adipic | H₂O | Steel | Good | 540 | 540 | Yes | >105 |
| Co(Ac)₂•4H₂O | | acid | | | | | | | |
| LiAc + | methanol | Adipic | — | SiO₂/TiO₂/Pt | Good | 540 | 540 | Yes | 105-115 |
| Co(Ac)₂•4H₂O | | acid | | | | | | | |
| LiAc + | methanol | Citric and | — | SiO₂/TiO₂/Pt | Good | 540 | 540 | Yes | 105-115 |
| Co(Ac)₂•4H₂O | | adipic | | | | | | | |
| | | acid | | | | | | | |
| LiAc + | ethanol | Adipic | Acetic | Steel | Good | 540 | 540 | Yes | >110 |
| Co(NO₃)₂•6H₂O | | acid | acid | | | | | | |
| LiAc + | methanol | Acrylic | Acetic | SiO₂/TiO₂/Pt | Good | 540 | 540 | No | — |
| Co(Ac)₂•4H₂O | | acid | acid | | | | | | |
| LiAc + | H₂O | Acrylic | — | Mica/Pt | Poor | 540 | 540 | No | — |
| Co(Ac)₂•4H₂O | | acid | | | | | | | |
| LiAc + | Ethylene | Acrylic | — | Mica/Pt | Poor | 540 | 540 | No | — |
| Co(Ac)₂•4H₂O | glycol | acid | | | | | | | |
| Ex. | 1 (Inv) | 2 (Inv) | 3 (Inv) | 4 (Inv) | 5 (Inv) | 6 (Inv) | 7 (comp) | 8 (comp) | 9 (comp) |

### Example 10 (Invention)

The solution is prepared by mixing 2 g of CoAc₂.4H₂O (hydrated cobalt acetate) and 0.53 g lithium acetate to which 15 ml of methanol is added. Adipic acid is used as a chelating agent (1.05 g) and water (0.5 ml) is used as a stabiliser to form a sol. From the latter, a film of monolayer structure and two films of multilayer structure comprising three and five layers, respectively, are produced. A heat treatment at 60° C. under vacuum is carried out after all of the corresponding layers have been deposited. The calcination is carried out on each of the films at a temperature of 540° C. for 15 min. The films thus formed are subjected to an annealing step carried out at 400° C. Table 2 details the features of each of the films obtained after calcination and after annealing.

TABLE 2

| Number of layers | 1 | 3 | 5 |
|---|---|---|---|
| Adherence after calcination | Yes | Yes | Yes |
| Thickness after calcination (μm) | 2.17 | 2.88 | 3.48 |
| Roughness after calcination (nm) | 47 | 67 | 84 |
| Thickness after annealing (μm) | 1.23 | 1.48 | 1.87 |
| Roughness after annealing (nm) | 195 | 340 | 669 |
| Adherence after annealing | Yes | Yes | Yes |

### Example 11 (Invention)

A solution is prepared by mixing 6 g of CoAc₂.4H₂O and 1.574 g of lithium acetate in 50 ml of methanol. This solution is stirred for 30 min. at ambient temperature before adding 5 ml of concentrated (96%) acetic acid then 2.303 g of succinic acid. The stirring is continued for 5 hours. The solution is deposited by spray coating on a 13 mm-diameter steel disc covered with a thin platinum layer (100 nm) raised to a temperature close to 80° C. After 10 passes, the film is dried under vacuum at 70° C. then calcinated in an oven preheated to 540° C. for 15 min. Ten new layers are then deposited on the first deposit under the same conditions. The film is once more dried then calcinated under the same conditions. An anneal is also applied to the film (increase from 100° to 540° C. in 30 minutes, 5 h at 540° C. then decrease from 540° C. to 100° C. in 30 minutes). The amount of active material on the disc is comprised between 1.1 and 1.2 mg. The discharge capacity of this material is comprised between 95 and 100 mAh/g for the first cycle and is higher than 90 mAh/g for the tenth.

### Example 12 (Invention)

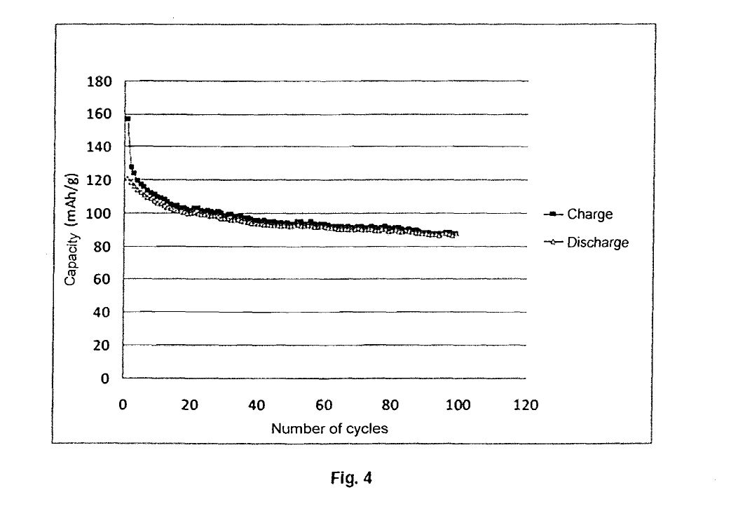

A solution is prepared by mixing 6 g of CoAc₂.4H₂O (cobalt acetate) and 1.57 g of lithium acetate, to which 50 ml of methanol is added. After the reactants have dissolved, 5 ml of acetic acid (stabilising agent) and 2.85 g of adipic acid (chelating agent) are added. The film is formed by depositing 30 layers of solution onto a platinum disc that is calculated for 15 minutes at 540° C. then annealed at 540° C. for 6 hours. The electrochemical performance of the electrodes thus prepared is illustrated in FIG. 4. FIG. 4 shows curves of charge and discharge capacity as a function of the number of cycles undergone by the electrode. From this figure it may be deduced that the specific insertion capacity is 73% of the theoretical specific capacity (137 mAh/g) after 20 cycles and 65% after 100 cycles.

### Example 13

### Preparation of a Film of Li₄Mn₅O₁₂ According to the Invention

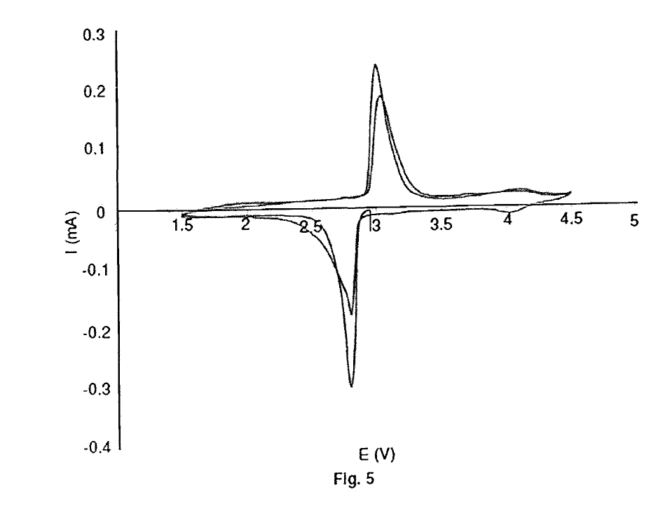

A solution is prepared by dissolving 1 g of lithium acetate and 4.67 g of manganese nitrate (Mn(NO₃)₂.4H₂O) in 25 ml of ethanol. Once the sols have completely dissolved, 3 ml of acetic acid (96%) and 2.24 g of adipic acid are added. The calcination of the electrodes is carried out at 400° C. The final anneal is also carried out of 400° C. for 10 h. The films are produced on stainless steel electrodes of 16 mm diameter, by depositing in succession a plurality of layers of precursors by spray coating. FIG. 5 shows a cyclic voltammetry curve of an Li₄Mn₅O₁₂ film prepared according to the present example and demonstrates the purity of the active material. The electrochemical performance measured in a C/10 regime is presented in table 3. This table shows a capacity per unit weight of more than 90% of the theoretical capacity per unit weight after 30 cycles.

TABLE 3

| Nb of | Li₄Mn₅O₁₂ | C_{dich1} | C_{dich10} | C_{dich30} | C_{dich100} |
|---|---|---|---|---|---|
| layers | weight | (mAh/g) | (mAh/g) | (mAh/g) | (mAh/g) |
| 10 | 0.82 mg | 178 | 168 | 154 | |
| 20 | 1.44 mg | 180 | 167 | 156 | 143 |
| 40 | 3.34 mg | 175 | 165 | 160 | |

The method according to the present invention also allows thin transition metal oxide films of multilayer structure to be prepared. Such films also adhere strongly to metal substrates and have low surface roughnesses. The present method also makes it possible to work at lower temperatures than methods described in the prior art in which the calcinating temperature is generally 750° C. or 800° C.

The terms and descriptions used here are given merely by way of nonlimiting illustration. Those skilled in the art will recognise that many variants are possible without departing from the spirit and scope of the invention such as described in the following claims and their equivalents; in the claims, all the terms used must, unless otherwise indicated, be understood as having their broadest possible meaning.

1. Method for manufacturing transition metal oxide films of formula AₐM_{b}Z_{c}O_{d}, in which:
A is an alkali metal, A advantageously being chosen from the group consisting of Li, Na and K, or their mixtures;
M is a metal or a mixture of metals chosen from the transition metals, lanthanides or actinides, M preferably being a transition metal or a mixture of transition metals chosen from the elements of columns 3 to 12 of the periodic table, M advantageously being chosen from the group consisting of Co, Ni, Mn, Fe, Cu, Ti, Cr, V and Zn, and their mixtures;
Z is a chemical element or a mixture of chemical elements chosen from columns 13 to 15 of the periodic table and preferably Z is chosen from the group consisting of B, N, P, Al, Si, Ge, In, Sn and Ga;
O is oxygen;
c is a real number higher than or equal to 0; a, b and d are real numbers higher than 0 and a, b, c, and d are chosen so as to ensure electroneutrality, said method comprising the following steps:
a) preparing a solution comprising one or more, preferably two or more than two, precursors containing one or more of the elements A, M, Z and O, a chelating agent and a polar organic solvent having a boiling point at atmospheric pressure below 150° C.;
b) forming a sol by stirring said solution; and
c) implementing the sol in the form of said transition metal oxide film by
c′) depositing one or more layers of said sol on a substrate; and
c″) preparing said transition metal oxide film by calcinating said one or more layers formed in step c′),
characterised in that
the chelating agent is chosen from aliphatic di- or tricarboxylic acids comprising 2 to 20 carbon atoms and salts or mixtures thereof, and in that said calcination in step c″) is carried out at a temperature comprised between 250° C. and 725° C.

2. Method according to claim 1, characterised in that said solution prepared in step a) also comprises a stabilising agent chosen from the group consisting of water or a carboxylic acid comprising 1 to 20 carbon atoms or a salt of said acid or a mixture thereof, the stabilising agent being different from the chelating agent.

3. Method according to either one of the preceding claims, characterised in that said transition metal oxide film prepared is of formula AₐM_{b}O_{d}, in which: A is chosen from the group consisting of Li, Na and K; M is chosen from the group consisting of Co, Ni, Mn, Fe, Cu, Ti, Cr, V and Zn; O is oxygen; and a, b and d are real numbers higher than O and chosen so as to ensure electroneutrality.

4. Method according to any one of the preceding claims, characterised in that the sol formed in step b) has a viscosity lower than 0.1 Pa·s.

5. Method according to any one of the preceding claims, characterised in that the chelating agent is chosen from aliphatic carboxylic diacids comprising 2 to 10 carbon atoms, their salts or their mixtures; or citric acid.

6. Method according to any one of the preceding claims, characterised in that the solvent is chosen from methanol, ethanol, propan-1-ol, isopropanol, butanol, pentanol, acetone, butanone, tetrahydrofuran, dimethylformamide, acetonitrile, diethyl ether, dichloromethane, 2-methoxyethanol and ethyl acetate.

7. Method according to any one of the preceding claims, characterised in that said one or more, preferably two or more than two, precursors of step a) are selected from the group consisting of salts or hydroxides of lithium, sodium, potassium, cobalt, nickel, manganese, iron, copper, titanium, chromium, vanadium and zinc, and salts of phosphoric acid, boric acid or a derivative thereof and their mixtures.

8. Method according to any one of the preceding claims, characterised in that said one or more, preferably two or more than two, precursors of step a) comprise a first precursor chosen from salts or hydroxides of lithium or sodium, and a second precursor chosen from salts or hydroxides of cobalt, nickel or manganese.

9. Method according to any one of the preceding claims, characterised in that the chelating agent is chosen from oxalic acid, succinic acid, adipic acid, citric acid or salts thereof or their mixtures.

10. Method according to any one of the preceding claims, characterised in that said transition metal oxide film has an average thickness comprised between 0.01 μm and 250 μm.

11. Method according to any one of the preceding claims, characterised in that said transition metal oxide film has a monolayer or multilayer structure, each layer having a thickness comprised between 0.01 and 2.5 μm.

12. Method according to any one of the preceding claims, characterised in that said substrate comprises carbon, platinum, gold, stainless steel, platinum on silica, ITO, platinum on a silica wafer or metal alloys comprising at least two elements selected from nickel, chromium and iron.

13. Method according to any one of the preceding claims, characterised in that the substrate has an Ra roughness lower than 500 nm.

14. Method according to any one of the preceding claims, characterised in that step c′) is carried out by spin coating, dip coating, spray coating, slide coating, screen printing, inkjet printing or roll coating.

15. Method according to any one of the preceding claims, characterised in that a heat treatment is carried out at a temperature below 250° C. in order to dry said layers deposited in step c′), before the calcinating step c″).

16. Method according to any one of the preceding claims, characterised in that the transition metal oxide film prepared is chosen from the group consisting of LiCoO₂, LiMnO₂, LiNi_{0.5}Mn_{1.5}O₄, LiCr_{0.5}Mn_{1.5}O₄, LiCo_{0.5}Mn_{1.5}O₄, LiCoMnO₄, LiNi_{0.5}Mn_{0.5}O₂, LiNi_{1/3}Mn_{1/3}CO_{1/3}O_{2 3}, LiNi_{0.8}Co_{0.2}O₂, LiNi_{0.5}Mn_{1.5-z}Ti_{z}O₄, where z is a number between 0 and 1.5, LiMn₂O₄, LiNiO₂, LiFePO₄, LiₓCoPO₄ where x is a number which may be 0.90, 0.95, 1 or 1.05, Li₄Mn₅O₁₂, LiMnPO₄ and Li₄Ti₅O₁₂, preferably LiNiO₂, Li₄Mn₅O₁₂, LiMn₂O₄, LiMnO₂, LiCoO₂ and Li₄Ti₅O₁₂.

17. Sol comprising one or more precursors containing one or more of the elements A, M, Z and O such as defined in claim 1, a chelating agent chosen from aliphatic carboxylic di- or triacids comprising 2 to 20 carbon atoms and salts or mixtures thereof and a polar organic solvent having a boiling point at atmospheric pressure below 150° C.

18. Sol according to claim 17, comprising:
two or more precursors chosen from a salt or a hydroxide of lithium, sodium, potassium, cobalt, nickel, manganese, iron, copper, titanium, chromium, vanadium and zinc, and the salts of phosphoric acid, boric acid or a derivative of the latter, and their mixtures;
a chelating agent chosen from aliphatic carboxylic di- or triacids comprising 2 to 20 carbon atoms and salts or mixtures thereof; and
a polar organic solvent having a boiling point at atmospheric pressure below 150° C.

19. Sol according to claim 17 or 18, comprising:
a salt or a hydroxide of lithium or sodium, or their mixture;
a salt or a hydroxide of cobalt, nickel or manganese, or their mixture;
adipic acid, succinic acid, citric acid or oxalic acid or a salt thereof; and
a polar organic solvent having a boiling point at atmospheric pressure below 150° C.

20. Sol according to any one of claims 17 to 19, characterised in that it comprises a lithium salt, a cobalt salt, adipic acid or a salt of the latter and a polar organic solvent having a boiling point at atmospheric pressure below 150° C.

21. Sol according to any one of claims 17 to 20, characterised in that it has a viscosity lower than 0.1 Pa·s.

22. Sol according to any one of claims 17 to 21, comprising a stabilising agent chosen from the group consisting of water or a carboxylic acid comprising 1 to 20 carbon atoms or a salt of said acid or a mixture thereof, the stabilising agent being different from the chelating agent.

23. Sol according to the preceding claim, in which the stabilising agent is chosen from water, acetic acid, propanoic acid, butanoic acid or pentanoic acid.

24. Sol according to claim 22 or 23, in which the proportion of stabilising agent in the sol may be comprised between 0.1 and 30% and preferably between 1 and 20% of the amount by weight of solvent contained in the sol.

25. Sol according to any one of claims 17 to 24, characterised in that it is homogeneous, said sol preferably not containing particles that are larger than 2 μm in size.

26. Use of a transition metal oxide film prepared according to any one of claims 1 to 16 as an electrode material, preferably a positive electrode material.

27. Use of a transition metal oxide film prepared according to any one of claims 1 to 16 as a material for protecting an electrode material.
